(19) United States
(12) Patent Application Publication
(10) Pub. No.: US 2026/0313331 A1
(43) Pub. Date: Oct. 8, 2026

(54) APPARATUS AND METHOD FOR REQUESTING AND REPORTING WIRELESS COMMUNICATION SENSING

(71) Applicant: LENOVO (SINGAPORE) PTE. LTD., Singapore (SG)

(72) Inventors: Konstantinos SAMDANIS, Munich (DE); Seyedomid TAGHIZADEH MOTLAGH, Oberursel (DE); Genadi VELEV, Darmstadt (DE)

(21) Appl. No.: 19/482,456

(22) PCT Filed: Jun. 30, 2023
(86) PCT No.: PCT/EP2023/067976

§ 371 Date: Nov. 7, 2025

(30) Foreign Application Priority Data
May 10, 2023 (GR) 20230100378

(51) Int. Cl. H04W 4/38

(52) U.S. Cl. CPC H04W 4/38

(57) ABSTRACT

There is provided an apparatus in a wireless communication system, the apparatus comprising: a processor; and a memory coupled with the processor, the memory containing instructions which, when executed by the processor, cause the apparatus to: receive a service request issued by a consumer entity, wherein the service request is either: a subscription request for the consumer entity to be subscribed to receiving a sensing result; or a request for the consumer entity to receive a single response comprising a sensing result; collect sensing data in accordance with the service request; processing the sensing data to create the sensing result; and transmit the sensing result for use by the consumer entity.

### FIELD

The subject matter disclosed herein relates generally to the field of implementing sensing with a wireless communication system. This document defines apparatuses and methods for use in wireless communication sensing.

### INTRODUCTION

Integrated sensing and communication (ISAC) enables the combination of sensing and communication systems. The inclusion of sensing capabilities, e.g., radar and radar-like sensing, in a communication network is enabled. Such a sensing capabilities can be used to obtain information related to, for example, the shape, size, orientation, speed, location, distances, or relative motion between objects using New Radio (NR) Radio Frequency (RF) signals and, in some cases, previously defined information available in Evolved Packet Core (EPC) and/or Evolved Universal Terrestrial Radio Access (E-UTRA) as described in TR 22.837.

### SUMMARY

A benefit of integrated sensing and communication in 5G is the fact that its operation is based on the existing wireless infrastructure, which provides coverage to leverage the benefits of radio signal sensing. Also, the 5G core tends to be able to assist in collecting further information related to user equipment (UEs), policies, analytics and can facilitate sensing exposure towards external network consumers, e.g., Application Functions (AFs).

Currently in TR 22.837 and 5G advanced IMT-2020, there have been introduced some preliminary requirements related to requesting sensing services and reporting sensing results, i.e., processed sensing output information. The assumption is that a sensing consumer shall issue a sensing request to a sensing function (SF) indicating the sensing service type, the sensing area or sensing target, and also providing the details of the sensing object (e.g., dimension details), the desired format of the sensing result, a sensing confidence, and details on how to transport the sensing results, i.e., which protocol to use and via which node sensing results shall be exposed to the consumer.

However, there is no clear description of a request and respond mechanism, i.e., subscription or request operation process, including a list of potential sensing specific attributes. Specifically, sensing in many cases deals with moving objects as described in TR 22.837, e.g., considering vehicles or drones. The sensing request needs to reflect potential mobility specific attributes related to moving UE, objects, or environment conditions. In addition, the request and respond does not consider any network exposure function (NEF) extensions related to handling sensing request and exposing sensing results towards untrusted AFs.

Aspects provided herein introduce: (i) sensing procedures for subscribing and requesting sensing services considering trusted and untrusted consumers, (ii) the content of sensing exposure focusing on, for example, mobility aspects, and (iii) sensing operations for subscribing, requesting, notifying, reporting, and fetching sensing results in the context on sensing procedure for subscribing and requesting sensing services.

Disclosed herein are procedures for requesting and reporting wireless communication sensing. Said procedures may be implemented by apparatuses disclosed herein.

There is provided an apparatus in a wireless communication system, the apparatus comprising: a processor; and a memory coupled with the processor, the memory containing instructions which, when executed by the processor, cause the apparatus to: receive a service request issued by a consumer entity, wherein the service request is either a subscription request for the consumer entity to be subscribed to receiving sensing results or a request for the consumer entity to receive a single response comprising sensing results; collect sensing data in accordance with the service request; process the sensing data to create sensing results; and transmit the sensing results for use by the consumer entity.

There is further provided a method in an apparatus in a wireless communication system, the method comprising: receiving a service request issued by a consumer entity, wherein the service request is either a subscription request for the consumer entity to be subscribed to receiving sensing results, or a request for the consumer entity to receive a single response comprising sensing results; collecting sensing data in accordance with the service request; and transmitting the sensing results for use by the consumer entity.

There is further provided an apparatus in a wireless communication system, the apparatus comprising: a processor; and a memory coupled with the processor, the memory containing instructions which, when executed by the processor, cause the apparatus to: receive, from a consumer entity, a service request, wherein the service request is either a subscription request for the consumer entity to be subscribed to receiving sensing results, or a request for the consumer entity to receive a single response comprising sensing results; process the service request to enforce one or more restrictions on one or more parameters of the service request; and transmit the processed service request to a Sensing Function in the wireless communication system.

There is further provided an apparatus in a wireless communication system, the apparatus comprising: a processor; and a memory coupled with the processor, the memory containing instructions which, when executed by the processor, cause the apparatus to: receive, from a Sensing Function, sensing results for transmission to a consumer entity; process the sensing results to enforce one or more restrictions on one or more parameters of the sensing results; and transmit the processed sensing results to the consumer entity.

There is further provided a method in an apparatus in a wireless communication system, the method comprising: receiving, from a consumer entity, a service request, wherein the service request is either a subscription request for the consumer entity to be subscribed to receiving sensing results, or a request for the consumer entity to receive a single response comprising sensing results; processing the service request to enforce one or more restrictions on one or more parameters of the service request; and transmitting the processed service request to a Sensing Function in the wireless communication system.

There is further provided a method in an apparatus in a wireless communication system, the method comprising: receiving, from a Sensing Function, sensing results for transmission to a consumer entity; processing the sensing results to enforce one or more restrictions on one or more parameters of the sensing results; and transmitting the processed sensing result to the consumer entity.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for requesting and reporting wireless communication sensing will now be described, by way of example only, with reference to the accompanying drawings, in which:

FIG. 1a is a schematic illustration showing a tight coupling ISAC network architecture;

FIG. 1b is a schematic illustration showing a tight coupling ISAC network architecture with Control Plane/User plane (CP/UP) split;

FIG. 1c is a schematic illustration showing an architecture in which the SF is collocated with the LMF;

FIG. 1d is a schematic illustration (not to scale) showing a loose coupling ISAC network architecture;

FIG. 2 depicts an embodiment of a wireless communication system in which requesting and reporting wireless communication sensing may be implemented;

FIG. 3 depicts a user equipment apparatus that may be used for implementing the methods described herein;

FIG. 4 depicts further details of the network node that may be used for implementing the methods described herein;

FIG. 5 is a process flow chart illustrating sensing subscribe and/or unsubscribe procedures in a wireless communication system;

FIG. 6 is a process flow chart illustrating sensing subscribe and/or unsubscribe procedures involving an untrusted AF and an NEF;

FIG. 7 is a process flow chart illustrating a sensing request procedure in a wireless communication system;

FIG. 8 is a process flow chart illustrating a sensing request procedure involving an untrusted AF and an NEF;

FIG. 9 illustrates a process flow chart showing a method in an apparatus in a wireless communication system;

FIG. 10 illustrates a process flow chart showing a method in an apparatus in a wireless communication system; and

FIG. 11 illustrates a process flow chart showing a method in an apparatus in a wireless communication system.

### DETAILED DESCRIPTION

For the purposes of the present disclosure, the following definitions from TR 22.837 have been adopted:
3GPP sensing data: Data derived from 3GPP radio signals impacted (e.g., reflected, refracted, and/or diffracted) by an object or environment of interest for sensing purposes, and optionally processed within the 5G system.
Sensing result: processed 3GPP sensing data requested by a service consumer.
Sensing service area: a service area where sensing services would solely rely on infrastructures and sensing technologies that can be assumed to be present anywhere where 5G is present. This includes both indoor and outdoor environments.
Sensing target area: an area that is to be sensed by deriving the dynamic characteristics of the area from any moving obstacles (e.g., cars, human, animals) from the impacted (e.g., reflected, refracted, and/or diffracted) wireless signals. There may be two kinds of target area, including:
   Static sensing target area: a pre-defined area that does not move from the sensing transmitter's perspective.
   Moving sensing target area: a trusted zone with a target that moves from the sensing transmitter's perspective.
Confidence level: this describes the percentage of all the possible measured sensing results that can be expected to include the true sensing result considering the accuracy.
Sensing Resolution: this describes the minimum difference in the measured magnitude of target objects (e.g. range, velocity) to be allowed to detect objects in different magnitude.
Maximum sensing service latency: time elapsed between the event triggering the determination of the sensing result and the availability of the sensing result at the sensing system interface.
Refreshing rate: rate at which the sensing result is generated by the sensing system. It is the inverse of the time elapsed between two successive sensing results reporting to the application server.

Sensing may relate to a target UE, objects without network connectivity, e.g. objects with no sim-card, or for obtaining the environment characteristics, e.g., sensing weather conditions to determine whether it is raining for example. Sensing may use the radio signals from one or more base stations, i.e., a sensing group whose location is known and whose sensing measurement data can be collected synchronously. The collected sensing data may then be provided to the mobile core network, which determines the sensing target and its corresponding characteristics.

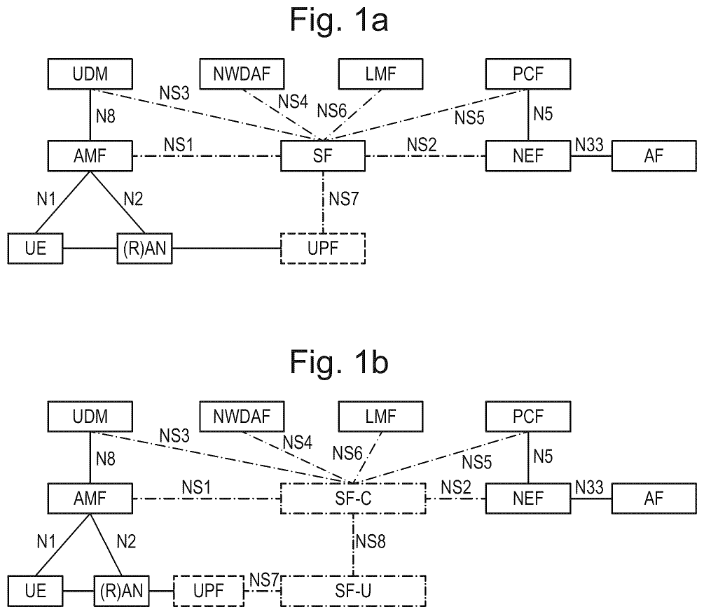

Integrated sensing and communication may enhance 5G core architecture by introducing a new Sensing Function (SF). Four proposals for enhancing the 5G core by introducing a SF as a dedicated or logical Network Function (NF) are considered in IMT-2020. These are illustrated schematically in FIGS. 1a-d.

FIG. 1a is a schematic illustration showing a tight coupling ISAC network architecture. In this architecture, the SF appears as a dedicated network function (NF) handling both: (i) the sensing control plane aspects such as the interaction with the sensing consumer via the NEF and information exchange with other NFs, for gathering UE information (e.g., from the Access and Mobility Management Function (AMF), Unified Data Management (UDM), Location Management Function (LMF), UE related policies from the Policy Control Function (PCF), and analytics from the Network Data Analytics Function (NWDAF)) and (ii) the sensing radio signals for performing the analysis or prediction for determining the sensing target.

FIG. 1b is a schematic illustration showing a tight coupling ISAC network architecture with Control Plane/User plane (CP/UP) split. In this architecture, the SF has two dedicated NF counter parts: (i) SF-C that handles the control plane aspects as described above (with respect to the tight coupling ISAC network architecture of FIG. 1a), and (ii) SF-U that is responsible for collecting the sensing radio signals via the user plane, i.e., via the Radio Access Network (RAN) and User Plane Function (UPF). The idea of this architecture is to split and offload heavy data volumes associated with sensing radio signals to the user plane to ensure light traffic, i.e., only singling, in the control plane.

FIG. 1c is a schematic illustration showing an architecture in which the SF is collocated with the LMF. The SF appears as a logical NF embedded in the LMF to perform sensing taking advantage of the knowledge of a UE location.

FIG. 1d is a schematic illustration (not to scale) showing a loose coupling ISAC network architecture. In this architecture the SF is independent of the 5G core, e.g., the SF may be used for local field scenarios or private networks, and the interaction with the 5G core is minimal. The main idea is to use the SF close to the RAN, e.g., to collect and process the sensing radio signals locally, and interact with 5G core for the purpose of exposure via the NEF, for getting the UE location from the AMF and for analytics (NWDAF).

A benefit of integrated sensing and communication in 5G is that its operation is based on the existing wireless infrastructure, which provides coverage to leverage the benefits of radio signal sensing. Also, the 5G core can assist in collecting further information related to the UEs, policies, analytics, and can facilitate sensing exposure towards external network consumers, e.g., AFs.

Currently in TR 22.837 and 5G advanced IMT-2020, there are introduced some preliminary requirements related to requesting sensing services and reporting sensing results, i.e., processed sensing output information. There may be an assumption that a sensing consumer shall issue a sensing request towards the SF indicating the sensing service type, indicating the sensing area and/or sensing target, providing the details of the sensing object (e.g., dimension details), providing the desired format of the sensing result, providing a sensing confidence, and providing details on how to transport the sensing results, i.e., which protocol to use and via which node, sensing results shall be exposed to the consumer.

However, conventionally there is no clear description of a request and respond mechanism, e.g., subscription or request operation process, including a list of potential sensing specific attributes. Specifically, sensing in many cases deals with moving objects as described in TR 22.837, e.g., considering vehicles or drones. The sensing request preferably reflects potential mobility specific attributes related to moving UE, objects, and/or environmental conditions. In addition, the request and respond does not consider any NEF extensions related to handling sensing request and exposing sensing results towards untrusted AFs.

This disclosure introduces: (i) sensing procedures for subscribing and requesting sensing services considering trusted and untrusted consumers, (ii) the content of sensing exposure focusing mainly on mobility aspects, and (iii) sensing operations for subscribing, requesting, notifying, reporting, and fetching sensing results in the context on sensing procedure for subscribing and requesting sensing services.

Prior to delving further into the details of the techniques presented herein, note that, as will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

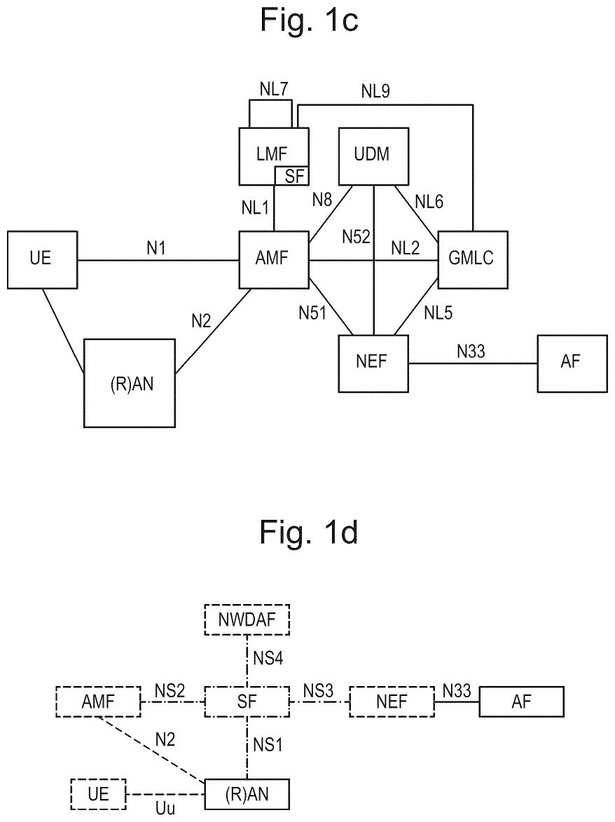

FIG. 2 depicts an embodiment of a wireless communication system 100 in which requesting and reporting wireless communication sensing may be implemented. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100. The wireless communication system may comprise a wireless communication network and at least one wireless communication device. The wireless communication device is typically a 3GPP User Equipment (UE). The wireless communication network may comprise at least one network node. The network node may be a network unit.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfox, LoraWAN among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

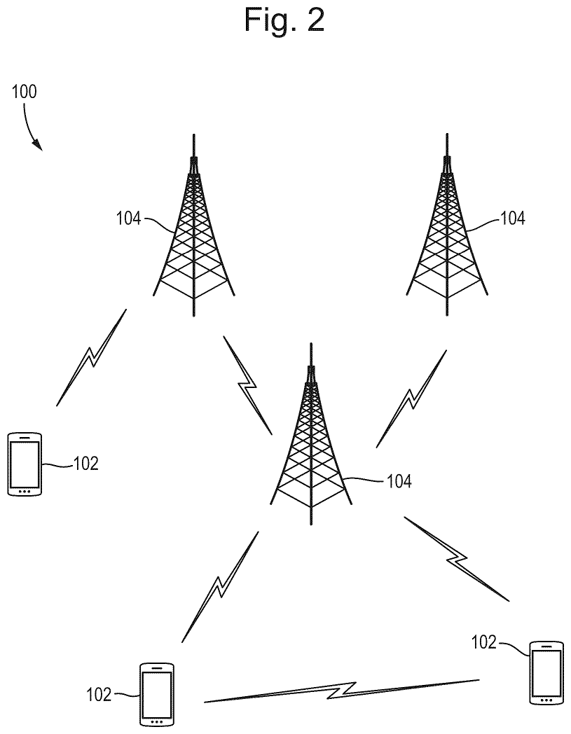

FIG. 3 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communication network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

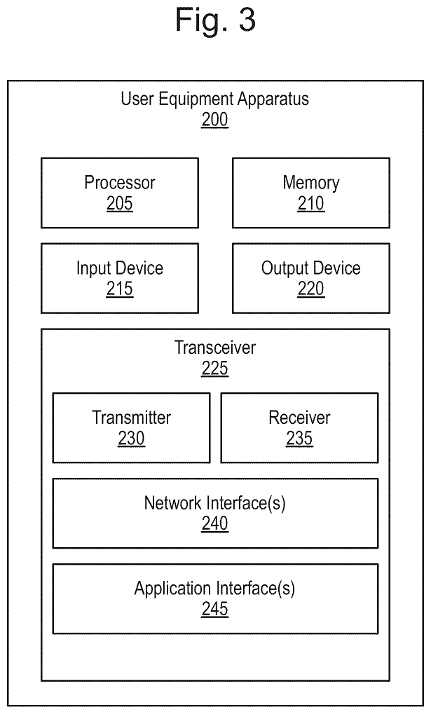

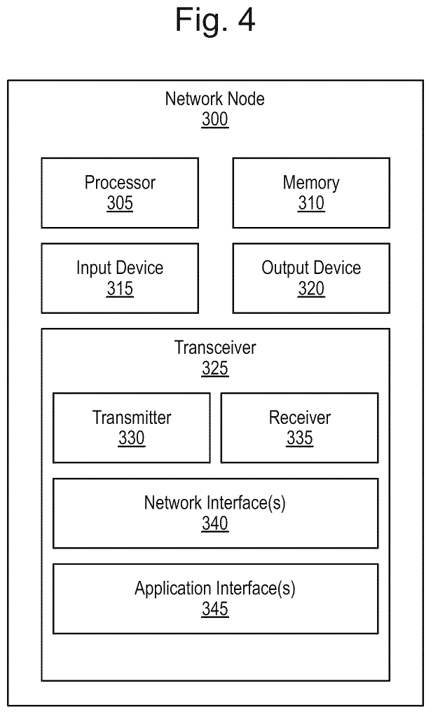

FIG. 4 depicts further details of the network node 300 that may be used for implementing the methods described herein. The network node 300 may be one implementation of an entity in the wireless communication network, e.g. in one or more of the wireless communication networks described herein. The network node 300 may comprise an SF, an SF service consumer, an NEF, and/or an AF such as those implemented in the methods described in more detail later below with reference to FIGS. 5 to 8. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

Embodiments described herein comprise procedures to enable a sensing subscription and/or a sensing request between a sensing consumer, referred to as SF Service Consumer, and the SF. The SF Service Consumer and the SF may interact via the NEF, for example, if the SF Service Consumer is an untrusted AF. In addition, embodiments described herein define the contents of sensing exposure and the service operations related to sensing subscription and notification and sensing requests. Embodiments described herein consider trusted and untrusted SF service consumers.

FIG. 5 is a process flow chart illustrating sensing subscribe and/or unsubscribe procedures 500 in a wireless communication system.

The sensing subscribe and/or unsubscribe procedures 500 involves a SF Service Consumer 502 and an SF 504. The sensing subscription or unsubscribing may be by the SF service consumer 502.

The SF Service Consumer 502 and/or the SF 504 may be the same as or in accordance with any network entity, function, or node described herein. For example, the SF Service Consumer 502 and/or the SF 504 may be the same as the network node 300 shown in FIG. 4 and described in more detail earlier above.

The sensing subscribe and/or unsubscribe procedures 500 can be used by any SF service consumer (e.g., including NFs, OAM, trusted AFs, etc.) to subscribe for or unsubscribe from receiving sensing results notifications, using an Nsf_SensingSubscription service. This service can also be used by a sensing consumer to modify existing sensing subscription(s).

At s506, the process 500 may optionally contain a preparation step at which the SF Service Consumer 502 checks if the SF 504 can support the sensing subscription in terms of being capable to collect the required 3GPP sensing data in the area of interest or related to a target UE, at the requested times. This can be deployed before the subscription by invoking a new service operation Nsf_SensingSubscription_Preparation. The parameters that may be provided by the SF service consumer 502 are described in more detail later below in the discussion of the “contents of sensing exposure”.

In some embodiments, the process of sensing preparation can alternatively use the Nsf_SensingSubscription_Subscribe message, introducing a preparation flag (e.g., a Boolean variable) to indicate when the subscribe operation is for sensing preparation purposes or for sensing subscription.

In some embodiments, if all of the one or more requirements of the sensing subscription can be met by the SF 504, the SF 504 may transmit, back to the SF Service Consumer 502, a confirmation message confirming that all of the one or more requirements of the sensing subscription can be met. Alternatively, if one or more of the one or more requirements of the sensing subscription cannot be met by the SF 504, the SF 504 may transmit, for use by the SF service consumer 502, a notification (e.g., an error message) indicating that the one or more requirements of the sensing subscription cannot be met by the SF 504, optionally also defining or specifying the cause, i.e., the reason.

At s508, the SF service consumer 502 subscribes to, or cancels its subscription (i.e., unsubscribes) from, sensing results by invoking one of the new service operations Nsf_SensingSubscription_Subscribe or Nsf_SensingSubscription_Unsubscribe. The parameters that can be provided by the SF service consumer in Nsf_SensingSubscription_Subscribe or Nsf_SensingSubscription_Unsubscribe are described in more detail later below in the discussion of the “contents of sensing exposure”.

When a subscription to a sensing result is received, the SF 504 determines whether it needs to collect radio signals, i.e., sensing data, to determine the sensing target(s) and/or determine their corresponding characteristics.

If the service invocation from the SF service consumer 502 is for a subscription modification (i.e., a change or update to an existing subscription), the SF service consumer 502 preferably includes an identifier (e.g., a subscription Transaction ID) of the subscription that is to be modified in the invocation of Nsf_SensingSubscription_Subscribe.

At s510, if the SF service consumer 502 is subscribed to sensing results, the SF 504 notifies the SF service consumer 502 with the sensing result(s) by invoking the new service operation Nsf_SensingSubscription_Notify, based on the sensing result reporting parameters request from the SF service consumer 502.

Multiple Nsf_SensingSubscription_Notify messages may be sent, e.g. periodically, from the SF 504 to the SF service consumer 502 in accordance with the established subscription. These Nsf_SensingSubscription_Notify messages are depicted schematically in FIG. 5 by a dashed arrow from the SF 504 to the SF service consumer 502.

If the SF 504 provides a sensing termination notification (e.g., because the sensing target object moves out of its serving area), then the consumer 502 may cancel the sensing result subscription by invoking the new service operation Nsf_SensingSubscription_Unsubscribe.

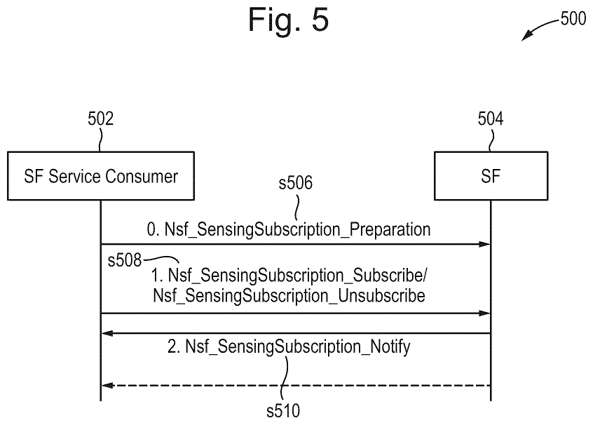

FIG. 6 is a process flow chart illustrating sensing subscribe and/or unsubscribe procedures 600 by an untrusted AF via an NEF.

The sensing subscribe and/or unsubscribe procedures 600 involve an SF 602, an NEF 604, and an AF 606 (which in this embodiment is an untrusted AF). The sensing exposure to an untrusted AF 606 may be performed via the NEF 604 by using the sensing subscription to the SF 602.

The SF 602, the NEF 604, and/or the AF 606 may be the same as or in accordance with any network entity, function, or node described herein. For example, the SF 602, the NEF 604, and/or the AF 606 may be the same as the network node 300 shown in FIG. 4 and described in more detail earlier above.

At s608, the NEF 604 controls the sensing exposure mapping among the untrusted AF 606 using an identifier (e.g., the subscription Transaction ID) with allowed Sensing ID(s) (i.e., identifying which sensing types are allowed for this specific untrusted AF 606), the associated inbound restrictions (i.e., applied to the subscription of the Sensing ID for an untrusted AF, e.g., sensing services that this specific untrusted AF 606 cannot request, and/or sensing for a certain serving area), and/or outbound restrictions (i.e., applied to notification of Sensing ID to the untrusted AF 606, e.g., that restrict or prevent the AF 606 from being provided with sensing results related to specific Event ID(s)).

The untrusted AF 606 can be configured with the appropriated NEF 604 to subscribe to sensing results, with the allowed Sensing ID(s) and with the allowed inbound restrictions (i.e., parameters and/or parameter values) for the subscription to each Sensing ID.

At s610, the untrusted AF 606 can optionally use a preparation step to determine whether the SF 602 can support the sensing subscription in terms of it being capable of collecting the required 3GPP sensing data in the area of interest or related to a target UE, at the requested times. This can be deployed as an additional step before the subscription, e.g., by introducing a new service operation Nnef_SensingSubscription_Preparation. The parameters that may be provided by the untrusted AF 606 are described in more detail later below in the discussion of the “contents of sensing exposure”.

At s612, if the preparation step request (i.e., Nnef_SensingSubscription_Preparation) complies with the inbound restrictions in the sensing exposure mappings, the NEF 604 directs the request to the respective SF 602 by invoking a new service operation Nsf_SensingSubscription_Preparation.

In some embodiments, if all of the one or more requirements of the sensing subscription can be met by the SF 602, the SF 602 may transmit, back to the AF 606 (via the NEF 604), a confirmation message confirming that all of the one or more requirements of the sensing subscription can be met or in other words that the sensing service can be supported. Alternatively, if one or more of the one or more requirements of the sensing subscription cannot be met by the SF 602, the SF 602 may transmit, back to the AF 606 (via the NEF 604), a notification (e.g., an error message) indicating that the one or more requirements of the sensing subscription cannot be met by the SF 504, and optionally additionally including the cause, i.e. the reason.

The process of sensing preparation can alternatively use the Nnef_SensingSubscription_Subscribe and Nsf_SensingSubscription_Subscribe messages, introducing a preparation flag (e.g., a Boolean variable) to indicate when the subscribe operation is for sensing preparation purposes or for sensing subscription. The parameters that may be provided by in the Nnef_SensingSubscription_Preparation and/or Nsf_SensingSubscription_Preparation are described in more detail later below in the discussion of the “contents of sensing exposure”.

At s614, the untrusted AF 606 subscribes to, or cancels its subscription (i.e., unsubscribes) from, sensing results via the NEF 604 by invoking one of the new service operations Nnef_SensingExposure_Subscribe or Nnef_SensingExposure_Unsubscribe. The parameters that can be provided by the AF 606 in Nnef_SensingExposure_Subscribe or Nnef_SensingExposure_Unsubscribe are described in more detail later below in the discussion of the “contents of sensing exposure”.

If the untrusted AF 606 needs to modify an existing sensing subscription at the NEF 604, the AF 606 may include an identifier (e.g., the subscription Transaction ID) in the invocation of Nnef_SensingExposure_Subscribe to identify the subscription that is to be modified. If the sensing subscription is authorized by the NEF 604, the NEF 604 may proceed with the steps below.

At s616, based on the request from the untrusted AF 606, the NEF 604 subscribes to or cancels a subscription to sensing results by invoking either the Nsf_SensingSubscription_Subscribe or Nsf_SensingSubscription_Unsubscribe service operation, respectively.

If the parameters and/or parameter values of the untrusted AF request comply with the inbound restriction in the sensing exposure mapping, the NEF 604 forwards the subscription to the respective SF 602 that supports the Sensing ID, including the parameters and/or parameter values from the untrusted AF request.

If the request from the untrusted AF 606 does not comply with the restrictions in the sensing exposure mapping, the NEF 604 may apply restrictions to the subscription request to the SF 602 (e.g., restrictions to parameters or parameter values of the Nsf_SensingSubscription_Subscribe service operations), based on operator configuration and/or may apply parameter mapping (e.g., geographical ordered coordinates mapping to TA(s)/Cell-id(s)).

The NEF 604 records the association of the sensing subscription from the untrusted AF 606 and the sensing subscription sent to the SF 602. The NEF 604 may select the appropriate SF 602 that supports the requested sensing results by the untrusted AF 606 using, for example, the procedures defined in TS 23.501 (i.e., with the assumption that SFs register their capabilities with the Network Repository Function (NRF), which can assist in the discovery process).

If the untrusted AF request is for a modification of existing sensing subscription(s), the NEF 604 may invoke Nsf_SensingSubscription_Subscribe to modify the sensing subscription identified by an identifier (i.e., the subscription Transaction ID) associated with the untrusted AF 606.

At s618, if the NEF 604 has subscribed to a SF 602 with a specific Sensing ID(s) for certain sensing results, the SF 602 notifies the NEF 604 with the sensing results or sensing termination notification by invoking a new service operation named Nsf_SensingSubscription_Notify.

At s620, when the NEF 604 receives the notification from the SF 602, the NEF 604 notifies the untrusted AF 606 with the sensing result or sensing termination notification by invoking Nnef_SensingExposure_Notify. The NEF 604 may apply outbound restrictions to the notifications to the untrusted AF 606 (e.g., restrictions to parameters or parameter values of Nnef_SensingExposure_Notify service operation) based on the sensing exposure mapping, and may apply parameter mapping for external usage (e.g., convert TA(s), Cell-id(s) to geographical area coordinates).

The untrusted AF 606 may check whether a sensing termination notification is present in the Nnef_SensingExposure_Notify. In the case that a sensing termination notification is present, the untrusted AF 606 may cancel the sensing result subscription by invoking the new service operation Nsf_SensingSubscription_Unsubscribe.

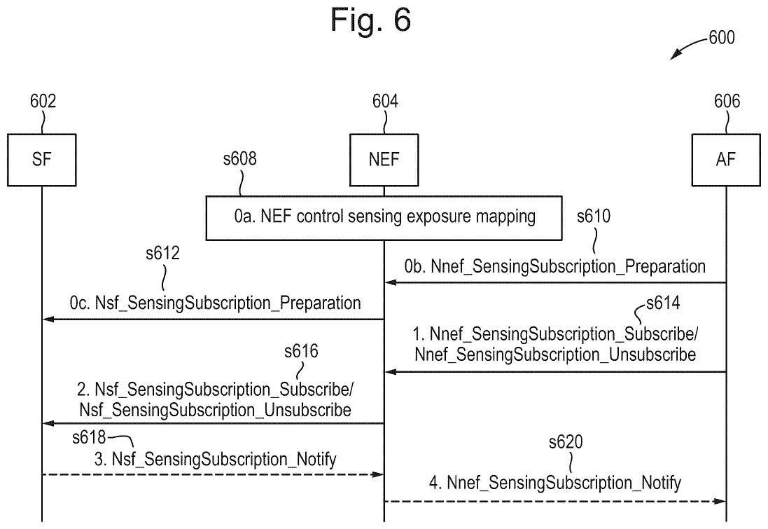

FIG. 7 is a process flow chart illustrating a sensing request procedure 700 in a wireless communication system.

The sensing request procedure 700 involves a SF Service Consumer 702 and an SF 704. The sensing request may be made by the SF service consumer 702.

The SF Service Consumer 702 and/or the SF 704 may be the same as or in accordance with any network entity, function, or node described herein. For example, the SF Service Consumer 702 and/or the SF 704 may be the same as the network node 300 shown in FIG. 4 and described in more detail earlier above.

The sensing request procedure 700 can be used by any SF service consumer (e.g., including NFs, OAM, trusted AFs, etc.) to request and receive sensing results, using an Nsf_SensingInfo service.

At s706, the SF Service Consumer 702 may optionally check whether the SF 704 can support the sensing request in terms of the SF 704 being capable of collecting the required 3GPP sensing data, in the area of interest or related to a target UE, at the requested times. This can be deployed by invoking a new service operation Nsf_SensingInfo_Preparation. The parameters that may be provided by the SF Service Consumer 702 are described in more detail later below in the discussion of the “contents of sensing exposure”.

In some embodiments, if all of the one or more requirements of the sensing request can be met by the SF 704, the SF 704 may transmit, back to the SF Service Consumer 702, a confirmation message confirming that all of the one or more requirements of the sensing request can be met or in other words that the sensing service can be supported. Alternatively, if one or more of the one or more requirements of the sensing request cannot be met by the SF 704, the SF 704 may transmit, back to the SF Service Consumer 702, a notification (e.g., an error message) indicating that the one or more requirements of the sensing request cannot be met by the SF 704, and optionally additionally specifying or defining the cause, i.e. the reason.

The process of sensing preparation can alternatively use the Nsf_SensingInfo_Request introducing a preparation flag (i.e., a Boolean variable) to indicate when the sensing request operation is for sensing preparation purposes or for sensing request.

At s708, the SF service consumer 702 requests sensing results by invoking a new service named Nsf_SensingInfo_Request. The parameters that can be provided by the SF service consumer in the Nsf_SensingInfo_Request are described in more detail later below in the discussion of the “contents of sensing exposure”.

When a request for a sensing result is received by the SF 704, the SF 704 determines whether it needs to collect radio signals, i.e., sensing data, to determine the sensing target(s) and/or determine their corresponding characteristics.

At s710, the SF 704 responds by invoking a new service named Nsf_SensingInfo_Request response with the sensing result based on the requested sensing result reporting parameters to the SF service consumer 702. The SF 704 may check whether a sensing termination request is indicated by the SF service consumer 702 before it provides the sensing results.

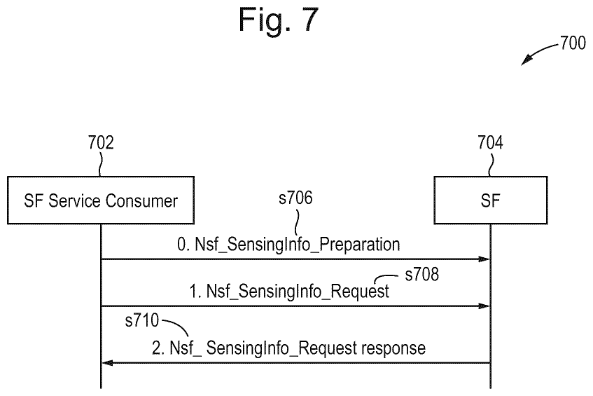

FIG. 8 is a process flow chart illustrating sensing request procedures 800 by an untrusted AF via an NEF.

The sensing request procedures 800 involve an SF 802, an NEF 804, and an AF 806 (which in this embodiment is an untrusted AF). The sensing exposure to an untrusted AF 806 may be performed via the NEF 804.

The SF 802, the NEF 804, and/or the AF 806 may be the same as or in accordance with any network entity, function, or node described herein. For example, the SF 802, the NEF 804, and/or the AF 806 may be the same as the network node 300 shown in FIG. 4 and described in more detail earlier above.

At s808, the NEF 804 controls the sensing exposure mapping among the untrusted AF(s) 806 using an identifier (e.g., a Transaction ID or a generic mapping identifier) with allowed Sensing ID(s), the associated inbound restrictions (i.e., applied to the Sensing ID requested by an untrusted AF), and/or the outbound restrictions (i.e., applied to the response of sensing result related to Sensing ID(s) towards the untrusted AF 806).

An untrusted AF 806 can be configured with the appropriated NEF 804 to request a sensing result, with the allowed Sensing ID(s) and with the allowed inbound restrictions (i.e., parameters and/or parameter values) for requesting sensing results from each Sensing ID.

At s810, the untrusted AF 806 can optionally use a preparation step to check whether the SF 802 can support the sensing request in terms of the SF 802 being capable of collecting the required 3GPP sensing data in the area of interest or related to a target UE, at the requested times. This can be deployed as an additional step before the sensing request is sent, i.e., by introducing a new service operation Nnef_SensingExposure_Preparation. The parameters that may be provided by the untrusted AF 806 are described in more detail later below in the discussion of the “contents of sensing exposure”.

At step s812, if the preparation step complies with the inbound restrictions in the sensing exposure mappings, the NEF 804 directs the request to the respective SF 802 by invoking a new service operation Nsf_SensingInfo_Preparation.

In some embodiments, if all of the one or more requirements of the sensing request can be met by the SF 802, the SF 802 may transmit, back to the AF 806 (via the NEF 804), a confirmation message confirming that all of the one or more requirements of the sensing request can be met. Alternatively, if one or more of the one or more requirements of the sensing request cannot be met by the SF 802, the SF 802 may transmit, back to the AF 806 (via the NEF 804), a notification (e.g., an error message) indicating that the one or more requirements of the sensing request cannot be met by the SF 802, and optionally additionally specifying or defining the cause, i.e. the reason.

The process of sensing preparation can alternatively use the Nnef_SensingExposure_Fetch and/or Nsf_SensingInfo_Request messages, introducing therein a preparation flag (i.e., a Boolean variable) to indicate when the sensing request operation is for sensing preparation purposes or for sensing request purposes.

At s814, the untrusted AF 806 requests to receive sensing results via the NEF 804 by invoking Nnef_SensingExposure_Fetch, a new service that is defined similarly to the fetch service operations as specified in TS 23.502. The parameters that may be provided by the untrusted AF 806 are described in more detail later below in the discussion of the “contents of sensing exposure”.

If the sensing request is authorized by the NEF 804, the NEF 804 proceeds with the steps below.

At s816, based on the request from the untrusted AF 806, the NEF 804 requests sensing results by invoking the new service operation named Nsf_SensingInfo_Request.

If the parameters and/or parameters values of the untrusted AF request comply with the inbound restriction in the sensing exposure mapping, the NEF 804 forwards or sends the request to the respective SF 802 that supports the Sensing ID, including the parameters and/or parameters values from untrusted AF 806.

If the request from the untrusted AF 806 does not comply with the restrictions in the sensing exposure mapping, the NEF 804 may apply restrictions to the request to the SF (e.g., restrictions to parameters or parameter values of the Nsf_SensingInfo_Request service operations), based on operator configuration and/or may apply parameter mapping (e.g., geographical ordered coordinates mapping to TA(s)/Cell-id(s)).

The NEF 804 may record the association of the sensing request from the untrusted AF 806 and the sensing request sent to the SF 802. The NEF 804 may select the appropriate SF 802 that supports the sensing results requested by the untrusted AF 806 using, for example, the discovery procedures defined in TS 23.501 (i.e., with the assumption that SFs register their capabilities with the NRF, which can assist in the discovery process).

At s818, the SF 802 responds by invoking Nsf_SensingInfo_Request response that contains the sensing result or a sensing termination notification to the NEF 804.

At s820, the NEF 804 responds with the sensing result or a sensing termination notification to the untrusted AF 806. The NEF 804 may apply outbound restrictions to the response towards untrusted AFs 806 (e.g., restrictions to parameters or parameter values of Nnef_SensingExposure_Fetch response service operation) based on operator configuration and may apply parameter mapping for external usage (e.g., convert TA(s), Cell-id(s) to geographical area coordinates).

Thus, processes for sensing data subscriptions or cancellation of subscriptions, and of sensing data requests are provided, for example, both trusted and untrusted AFs.

What will now be discussed is the contents of sensing exposure. The contents of the sensing exposure comprise: (i) the parameters used by an SF service consumer (e.g. an SF service consumer 502, 702, or an AF 606, 806) to subscribe, modify, or request a sensing service from a SF; and (ii) the contents of the notification or response from the SF towards the SF service consumer (e.g. an SF service consumer 502, 702, or an AF 606, 806).

Contents of sensing exposure used for subscribing or requesting sensing services may contain one or more parameters selected from the group of parameters consisting of:
A “Sensing ID”. This parameter identifies the requested sensing “job” (or sensing type), e.g., “Verify Object Route”, “Detect Object”, “Estimate Object position”, “Estimated Object Velocity”, “Estimate Object mechanical periodicity”, etc. This may assume that certain sensing “job” identifiers are specified publicly. Using this parameter, a SF service consumer knows what to expect as a sensing result or goal (e.g., detection of a shape, size, orientation, related to a sensing target) when it asks for, e.g., a “Detect Object” sensing job. Alternatively, since the sensing “jobs” can be numerous with potentially new ones been defined at any time, the Sensing ID parameter can serve as a field or container that allows the SF Service Consumer to communicate the desired sensing “job” to the SF, assuming that sensing “job” names or IDs are known, i.e., pre-configured, between the entities involved based on Service Level Agreements (SLA).
“Sensing Description”. This parameter provides the dimensions or shape (e.g., a three-dimensional shape) of the sensing object of interest and/or environmental conditions and/or other related characteristics for detecting and separating objects. In some embodiments, the sensing description may further include positioning information of an object, an expected velocity, orientation, heading or movement direction, or a subset or combination thereof. In some embodiments, the sensing description may further include information related to the background environment, e.g., positioning or shape information of the other objects or environment parts different than the object of interest for sensing. Alternatively, the sensing object or environment condition description can be provided via an AI/ML model prepared, i.e., trained, to identify certain objects or environment conditions and other related attributes. Typically, it is provided by the SF service consumer as a set of values, or in the case of the AI/ML model it can be provided by a link that can help the SF to acquire (e.g. download) the AI/ML model or download or obtain an AI/ML model via model serialization or containerization.
“Object Type ID”. This parameter may be provided to distinct different categories of objects, and may be associated with each different Sensing Description, e.g., for a Sensing ID equal to “Road Safety”, different Object Type IDs may be implemented to distinguish cars, animals, and humans.
“Transaction ID”. This reference identifier may be used when a SF service consumer subscribes or requests a Sensing ID. The transaction ID parameter may be used for identifying and verifying a subscription request session or a sensing request in one or more related transactions, e.g., when providing a notification sensing result or when the SF consumer needs to modify its subscription.
“Notification address”. This parameter may specify an address to send the sensing result, for example in cases where the SF service consumer is issuing a sensing request on behalf of another node, which consumes the sensing result.
“Use case context”. This parameter may indicate the usage context of a sensing service (Sensing ID), i.e., purpose of using sensing (e.g., to identify a car, or an animal approaching the road for assuring road safety or check the accuracy of the route taken by a drone, etc.). This parameter can be used to select the most relevant AI/ML model in the SF when several models are already available there. The values of this parameter may be public, i.e., from a list of pre-defined use case context identifiers, or private, but this field may still be used to carry these private parameters.
“Sensing Filter Information”. This parameter indicates the conditions that are to be fulfilled for notifying or reporting the sensing results. Typically, these are optional parameters that may assist to select when and which type of sensing results shall be reported and may include:
   An area of interest. This may be expressed in terms of a geographical area represented, e.g., as a set of ordered coordinates or neighbor in a town with predetermined limits.
   A time window of interest. If this parameter is defined, it may be the case that only sensing events that have been created in the specified time interval are considered for generating the sensing results. The time window can be in the past (i.e., using collected radio signals) or in the future.
   A UE(s) of interest. If this parameter is specified, sensing may be applied only for certain specified UE(s). For example, UE(s) of interest in the sensing subscription/request can be used to define Event ID(s), i.e., when such indicated UEs are closer to each other (e.g., less than a threshold of 10 m) or close to any other known/detected object. UE(s) of interest can be used to indicate a sensing target that is co-located and/or attached or a sensing target in where the UE(s) of interest are contained, e.g., perform sensing for an object inside a lorry track. UE(s) of interest may relate to the following characteristics or conditions:
      i) Slice connectivity, i.e., S-NSSAI, (e.g., for UEs only in vehicular slice).
      ii) Subscription profile, (e.g., sensing as a UE added value service). iii) DNN connectivity, (e.g., when a UE a security operator consumes surveillance video from certain application server and needs to combine it with sensing).
      iv) Application type identifier, (e.g., for UEs only when running a specific application type like for an emergency rescue).
      v) UE type, (e.g., for vehicle or drone UEs only).
   Event of interest. This parameter identifies at least one or a set of conditions, which trigger the initiation of sensing in the context of a specific Sensing ID, i.e., the conditions upon which the SF needs to start collecting sensing data to prepare a sensing result. These conditions may relate to a sensing target and can be defined in terms of one or more of the geographical area or location, velocity, direction, relative distance, size changes, and/or detection of another object, etc. For example, an Event of interest can be defined when a sensing target is detected with a velocity higher than 20 m/s, or when a sensing target is within 10 m distance from an indicated reference position. An Event of interest may also define a common condition among a set of sensing targets, e.g., entering an Area of interest, or in relation with another sensing target, e.g., a distance less than 2 m between two objects. Additionally, or alternatively, an Event of interest may define a sensing trigger condition when another sensing target is detected at a specified location, e.g., to start sensing other target sensing objects at the same location. Different Events of interest can be associated with distinct Event IDs for reference purposes. The triggering conditions that the Events of interest define may be categorized in as follows:
      i) Threshold conditions. These may be measurable as a value, a set of coordinates, or three-dimensional coordinates in terms of speed, direction, and/or distance, etc. Thresholds can be defined based on a given limit with a certain direction, i.e., below, above or crossed. Typically, a threshold is defined with an acceptable deviation and hysteresis, i.e., it fires a trigger when the given threshold level is not only met or crossed, but when it is surpassed beyond or below an indicated acceptable deviation from that given threshold level. In this way “ping pong” effects around a threshold level may be limited.
      ii) Matching conditions. These may be measurable when a value or set of values related to a sensing target are contained or are subsets of a given set. For example, when the location of a sensing target is within a specified Area of interest or when the movement of a sensing target, i.e., its trajectory is within a specified Area of interest.
      iii) Target detection conditions. These may be measurable via the activity of another sensing target, i.e., when another object is detected, e.g., when a goat is detected close to a road, then start sensing a specified Area of interest for the next 10 mins to detect if a herd of goats is nearby and send a risk alert to pass by drivers.
   “Mobility profile”. This profile may be related to a target sensing UE(s) or object(s) type, and may consider one or more of the following parameters:
      i) On the interest of movement-once the target of sensing starts moving.
      ii) With speed or velocity of interest-once the target of sensing moves with a certain speed range or beyond/below a specified limit.
      iii) Path of interest, for a specified trajectory (i.e., set of 2D or 3D coordinates) where the target of sensing is expected to move, e.g., a planned travel route of a drone for sensing if it is followed accurately. The path of interest can be provided by a GPS system.
      iv) Direction of interest-once the target of sensing starts moving towards a certain direction.
      v) Preferred travel distance for sensing resolution, e.g., specified in meters, or cell level.
      vi) Distance of interest around a reference point. This parameter can be a fixed value or set of fixed values (e.g., a table with different fix value options) or it can be a function that assists to calculate the distance considering the speed related to the moving target of sensing. The relative distance may be measured in three dimensions, or in two dimensions (e.g., excluding zenith/elevation) or in one dimension (e.g., area of maximum 2-meters distance in the x-axis direction of a known coordinate system). The distance of interest around a reference point can be used, e.g., for safety related to a moving vehicle considering its speed to calculate the sensing distance around it. The reference point may be one or more of a static or moving sensing target object (e.g., may be associated to an Object ID), a static or moving known object (e.g., again associated to an Object ID), a static or mobile UE (e.g. associated to a UE ID indicated by the SF Service Consumer).
      vii) Relative distance of interest between two or more reference points. This parameter can be a fixed value or set of fixed values (e.g., a table with different fix value options) or it can be a function that assists to calculate the distance considering the speed related to the moving target of sensing. The relative distance may be measured in three dimensions, or in two dimensions (excluding zenith/elevation) or in one dimension (e.g., area of maximum 2-meters distance in the x-axis direction of a known coordinate system). The relative distance of interest can be used, e.g., for safety among moving vehicles. The reference point may be one or more of a static or moving sensing target object (e.g., may be associated to an Object ID), a static or moving known object (e.g., again associated to an Object ID), a static or mobile UE (e.g., associated to a UE ID indicated by the SF Service Consumer).
      viii) Abnormal behaviour related to a target of sensing, e.g., when a target suddenly stops while it previously was moving, or crashes into another object, or moves out of the way. These cases can be defined as fixed or as a function of inter-related values between targets of sensing, e.g., a zero speed, a zero distance between vehicles and change in previous shape. A relative deviation from a known road or route, or a deviation from an expected speed can also serve as an indication of abnormal mobility.
“Target of Sensing Reporting”. This parameter indicates the UE(s), object(s) and/or environment conditions for which sensing information is requested. The parameter may indicate entities such as: (i) a specific UE or object type, (ii) a group of UEs or objects type, (iii) any UE or object type, i.e., all UEs or objects type, and/or (iv) non-UE or non-object type for environment condition irrespective of UEs or specific objects.
Target Time Period of Sensing Subscription. This parameter can be specified as, e.g., [start time, stop time] or (start, duration), to indicate the time related to a sensing subscription.
Sensing key performance indicators (KPIs) associated with a specific Sensing ID. These may include:
   “Preferred level of resolution”. This parameter indicates properties of the sensing data, e.g., position or velocity resolution of an object in a 3D space of a defined 2D plane or a defined 1D direction. The resolution can vary depending on the movement of the sensing target, e.g., movement of target object(s) or UE(s), and/or the movement of sensing radio equipment in combination with the sensor capabilities. There are four types of resolution to consider for any dataset including the following:
      i) Radiometric resolution. This is the amount of information that each pixel can carry, i.e., a higher radiometric resolution allows higher availability to store information related with the sensing target.
      ii) Spatial resolution. This is defined by the size of each pixel that a sensing equipment can scan or collection information from and represent within a digital image.
      iii) Spectral resolution. This is the ability of a radio sensor equipment to use finer wavelengths, i.e., support more and/or narrower bands. Narrower wavelengths for a given band, accomplish finer spectral resolution.
      iv) Temporal resolution is the time it takes to revisit the same observation point or area assuming that the sensing equipment is rotating or moving with a regular pattern.
   “Preferred level of sensing accuracy”. This may take the values “Low”, “Medium”, “High” or “Highest”. This parameter describes or indicates the expectation on how close an estimation shall be compared to the ground truth value. This parameter may be applied to the estimation of a sensing target positioning or velocity, etc. For example, the sensing accuracy may indicate position or velocity estimation of an object in a 3D space of a defined 2D plane or a defined 1D direction.
   “Preferred level of reliability”. This parameter indicates the expected consistency for collecting sensing data per Sensing ID considering the probability of performing consistently well per sensing equipment (e.g., per base station) and/or the probability of using other sensing equipment, e.g., other base stations, to replace the one(s) that currently carry out a sensing “job”, in case of a fault.
   “Preferred maximum false alarm probability”. This parameter denotes the ratio of detecting an Event per Sensing ID that does not represent the characteristic(s) or the state(s) of a sensing target or environment, e.g., a target object did not enter an indicated area of interest, over the plethora of all Events during a pre-configured period during which SF determines sensing results. The false alarm probability can assist a SF service consumer to select a SF.
   “Preferred maximum missed-detection probability”. This parameter denotes the ratio of missing an Event per Sensing ID to acquire a sensing result related to a sensing target or environment, (e.g., missing to initiate sensing when the velocity of a sensing target surpasses the limit indicated by the corresponding sensing Event), over all Events during a pre-configured period during which SF determines sensing results. The missed-detection probability can assist a SF service consumer to select a SF.
“Sensing result reporting”, which may include one or more of the following parameters:
   Time scheduling, which may be related to:
      i) Refreshing rate at which sensing data is collected and the sensing result is generated.
      ii) Preferred reporting periodicity for reporting sensing results to the consumer. It can have a value equal to the refreshing rate or lower if it is required to accommodate several sensing results in a single sensing report.
      iii) Time until when the sensing result is needed (maximum sensing latency). This may indicate the latest time that the sensing consumer expects to receive a sensing result from a SF. It can be used for indicating delay tolerance to assist the SF time schedule and shall not be set to a value less than the selected SF supported sensing delay. If the time expires the SF may send an error notification.
      iv) Urgency flag for reporting a sensing result immediately or as fast as it can be produced.
   “Reporting thresholds per Sensing ID”. These thresholds may indicate network conditions (e.g., load limits, throughput, energy saving) that regulate when a sensing result shall be notified towards the SF service consumer. Such regulation may comply with operator policies related to background network traffic control or network exposure. Reporting thresholds are defined based on a given limit with a certain direction, i.e., below, above or crossed with an acceptable deviation and hysteresis, to assure that a threshold is triggered when it is surpassed beyond or below the indicated acceptable deviation, e.g., to avoid “ping pong” effects around a threshold level.
   “Event completion per Sensing ID” which may be generated once a SF has prepared a sensing result related to a specific Event ID. The conditions that characterize an Event as completed depend on the way the Event is defined. For example, in case of a threshold condition, an Event may be deemed completed when a sensing target surpasses a velocity limit and then drops back after a time-period wherein sensing was performed. Alternatively, considering matching conditions, an Event may be deemed completed when a sensing target that has entered a given Area of Interest has left. In the case of a target detection, an Event may be deemed completed after a time-period or when another target detection incident occurred.
   Maximum number of UEs or objects requested by the consumer to limit the amount included in the list of sensing per notify or response to a request.
   Preferred order of sensing results when a list of is returned, possibly with a criterion for identifying the property of the results to which the preferred ordering is applied.
“Sensing Result Provision Strategy”. This parameter indicates when sensing results shall be reported considering one or more of: (i) binary strategy that reports sensing results only when the preferred level of accuracy is reached or when threshold conditions are met, and/or (ii) gradient strategy that reports sensing results periodically irrespective of other factors.
“Preparation Flag”. This indicates if the subscription or request sensing exposure is issued for the purpose of checking whether the SF can support the sensing subscription in terms of being capable of collecting the required 3GPP sensing data in the area of interest or related to a target UE, at the requested times. The Preparation Flag can be realized by adopting a Boolean variable to indicate if the subscribe or request operation is for sensing preparation purposes or not, i.e., or it is for conventional sensing subscription or request.

Contents of sensing exposure included in a notification or response towards the SF service consumer may contain one or more parameters selected from the group of parameters consisting of:
“Sensing results”, which may be per Sensing ID and/or per Event ID. The sensing results contain the sensing output as requested. The sensing results are contained in a notification or response if the sensing termination notification is not presented.
“Sensing termination notification”. This parameter lets the consumer know that the subscription is cancelled or that the response can no longer be provided, since the SF cannot serve it, e.g., because the target object moved out of the serving area of the SF.
“Transaction ID”. This parameter indicates the subscription identity or request identity (which may be applied/valid only in case of sensing subscription or request) in all corresponding transactions towards the SF service consumer.
“Timestamp of generating a sensing result”. This parameter indicates to the SF service consumer the time of creating sensing results. This can assist the SF service consumer to understand how to use the sensing result.
Location of target object that is contained in the sensing result.
“Object ID”. This parameter identifies the different objects of interest contained in the sensing result that are part of the same Object Type ID category. Object ID can be either a combined identifier that contains the Object Type ID or a separate one that complements the Object Type ID. For example, the Object Type ID “car” may contain different Object ID associated with different cars that are sensed in the same area of interest. The Object ID can then be used to refer to a particular object among several sensing results reporting. For example, an Object ID of a detected car indicated in a previous sensing report may be used in a subsequent report together with position information associated with the Object ID to indicate, to the SF service consumer, the updated position information of the previously detected car.
“Environment Condition ID”. This parameter identifies the different environmental conditions contained in the sensing result that are part of the Sensing Description, e.g., rain or snow may be associated with different respective IDs in the sensing result reporting.
A confidence in sensing prediction based on the amount of collected radio signal data, i.e., sensing data.
“Revised waiting time”. This parameter may indicate to the consumer a proposed waiting time value for when sensing results can be ready once an error response or error notification is issued.

The following information is useful in understanding examples of new services for sensing, which may be implemented in certain embodiments by apparatuses and methods described herein.

### Nsf_SensingSubscription Service

Service Description: This service enables the consumer to subscribe/unsubscribe for sensing results.
When the subscription for sensing is accepted by the SF, the SF service consumer receives from the SF an identifier (e.g., Transaction ID) allowing to further manage (modify, delete) this subscription. The modification of Analytics subscription can be enforced by the SF based on operator policy and configuration.

### Nsf_SensingSubscription_Preparation Service Operation

Service operation name: Nsf_SensingSubscription_Preparation.
Description: Optional preparation before a subscription to SF sensing results with specific parameters.
Inputs, Required: (i) (set of) Sensing ID(s), (ii) Sensing Filter Information (e.g., Area of Interest, UE(s) of interest, etc.), (iii) Target Time period of Sensing subscription. Inputs, Optional: (i) Use case context, (ii) Target of Sensing Reporting (per Sensing ID), (iii) Sensing Filter Information, (iv) Sensing Results Reporting, (v) Sensing Result Provision Strategy, (vi) if sensing focuses on objects: (vi.a) Sensing Description, (vi.b) Sensing Object Type ID, (vii) Sensing KPIs.
Outputs Required: When the subscription preparation is accepted a positive acknowledgement. Otherwise, if the subscription preparation cannot be fulfilled, a negative response indicating the cause, e.g., wireless resource shortage, object out of range, etc.
Outputs, Optional: None.

### Nsf_SensingSubscription_Subscribe Service Operation

Service operation name: Nsf_SensingSubscription_Subscribe.
Description: Subscribes to SF sensing results with specific parameters.
Inputs, Required: (i) (set of) Sensing ID(s)/Event ID(s), (ii) Target of Sensing Reporting (per Sensing ID and/or Event ID), (iii) Target Time period of Sensing subscription, (iv) Transaction ID (if subscription is already established and the intention is to request a modification).
Inputs, Optional: (i) Use case context, (ii) Notification Address, (iii) Sensing Filter Information, (iv) Sensing Results Reporting, (v) Sensing Result Provision Strategy, (vi) if sensing focuses on objects: (vi.a) Sensing Description, (vi.b) Sensing Object Type ID, (vii) Sensing KPIS, (viii) Result provisioning strategy, (ix) Preparation Flag. Outputs Required: When the subscription is accepted: Transaction ID (required for any subscription transaction). When the preparation flag is active then the response indicates if the preparation conditions were met or not. When the subscription is not accepted, an error response or a sensing termination notification.
Outputs, Optional: None.
Note: When the Nsf_SensingSubscription_Subscribe is used it may contain at least the following parameters but not limited to: (i) (set of) Sensing ID(s), (ii) Area of Interest, (iii) Target UEs (if applicable), (iv) Target Time Period of Sensing Subscription.

### Nsf_SensingSubscription_Unsubscribe Service Operation

Service operation name: Nsf_SensingSubscription_Unsubscribe.
Description: Unsubscribe to SF sensing service, i.e., sensing result.
Inputs, Required: Transaction ID.
Inputs, Optional: None.
Outputs, Required: Operation execution result indication.
Outputs, Optional: None.

### Nsf_SensingSubscription_Notify Service Operation

Service operation name: Nsf_SensingSubscription_Notify.
Description: SF notifies the SF service consumer of the sensing result that has subscribed per Sensing ID/Event ID.
Inputs, Required: If the request is accepted: (i) Sensing ID(s)/Event ID(s), (ii) Sensing Result, (iii) Transaction ID that has been assigned by the SF service consumer during the subscription. When the request is not accepted, an error response or a sensing termination notification.
Inputs, Optional: (i) Timestamp of Generating a Sensing Result, (ii) Location of Target Object, (iii) Confidence in Sensing Prediction, (iv) Revised waiting time, (v) Object ID that identifies the different objects contained in the sensing result in relation with the Object Type ID (if sensing focuses on objects) or (vi) Environment Condition ID.
Outputs, Required: Operation execution result indication.
Outputs, Optional: None.

### Nsf_SensingInfo Service

Service description: this service enables the SF service consumer to request and get from a SF sensing results.

### Nsf_SensingInfo_Preparation Service Operation

Service operation name: Nsf_SensingInfo_Preparation.
Description: Optional preparation before issuing a request to SF sensing results with specific parameters.
Inputs, Required: (i) (set of) Sensing ID(s), (ii) Sensing Filter Information (e.g., Area of Interest, UE(s) of interest, Time window of interest).
Inputs, Optional: (i) Use case context, (ii) Target of Sensing Reporting (per Sensing ID), (iii) Sensing Filter Information, (iv) Sensing Results Reporting, (v) Sensing Result Provision Strategy, (vi) if sensing focuses on objects: (vi.a) Sensing Description, (vi.b) Sensing Object Type ID, (vii) Sensing KPIs.
Outputs Required: When the subscription preparation is accepted a positive acknowledgement. Otherwise, if the subscription preparation cannot be fulfilled, a negative response indicating the cause, e.g., wireless resource shortage, object out of range, etc.
Outputs, Optional: None.

### Nsf_SensingInfo_Request Service Operation

Service operation name: Nsf_SensingInfo_Request.
Description: The SF service consumer requests a specific sensing result.
Inputs, Required: (i) (set of) Sensing ID(s)/Event ID(s), (ii) Target of Sensing Reporting (per Sensing ID and/or Event ID), (iii) Time window of interest.
Inputs, Optional: (i) Use case context, (ii) Notification Address, (iii) Sensing Filter Information, (iv) Sensing Results Reporting, (v) Sensing Result Provision Strategy, (vi) if sensing focuses on objects: (vi.a) Sensing Description, (vi.b) Sensing Object ID, (vii) Sensing KPIS, (viii) Preparation Flag.
Outputs, Required: If the request is accepted: (i) Sensing ID(s)/Event ID(s), (ii) Sensing Result. When the preparation flag is active then the response indicates if the preparation conditions were met or not. When the request is not accepted, an error response or a sensing termination notification.
Outputs, Optional: (i) Timestamp of Generating a Sensing Result, (ii) Location of Target Object, (iii) Confidence in Sensing Prediction, (iv) Revised waiting time, (v) Object ID that identifies the different objects contained in the sensing result in relation with the Object Type ID (if sensing focuses on objects) or (vi) Environment Condition ID.
Note: When the Nsf_SensingInfo_Request is used it may contain at least one the following parameters but not limited to: (i) (set of) Sensing ID(s), (ii) Area of Interest, (iii) Target UEs (if applicable), (iv) Time window of interest.

### Nnef_SensingExposure Service

This service allows a SF service consumer (i.e., an untrusted AF) to subscribe or request sensing results via the NEF.

### Nnef_SesningExposure_Subscribe Operation

Service operation name: Nnef_SensingExposure_Preparation.
Description: Optional preparation for an untrusted AF before a subscription to SF sensing results with specific parameters.
Inputs, Required: (i) (set of) Sensing ID(s), (ii) Sensing Filter Information (e.g., Area of Interest, UE(s) of interest, etc.), (iii) Target Time period of Sensing subscription.
Inputs, Optional: (i) Use case context, (ii) Target of Sensing Reporting (per Sensing ID), (iii) Sensing Filter Information, (iv) Sensing Results Reporting, (v) Sensing Result Provision Strategy, (vi) if sensing focuses on objects: (vi.a) Sensing Description, (vi.b) Sensing Object Type ID, (vii) Sensing KPIS.
Outputs Required: When the subscription preparation is accepted a positive acknowledgement. Otherwise, if the subscription preparation cannot be fulfilled, a negative response indicating the cause, e.g., wireless resource shortage, object out of range, etc.
Outputs, Optional: None.

### Nnef_SensingExposure_Subscribe Operation

Service operation name: Nnef_SensingExposure_Subscribe.
Description: The SF service consumer (i.e., untrusted AF) subscribes or modifies an existing subscription on sensing results.
Inputs, Required: (i) (set of) Sensing ID(s)/Event ID(s), (ii) Target of Sensing Reporting (per Sensing ID and/or Event ID), (iii) Target Time period of Sensing subscription, (iii) Transaction ID (if subscription is already established and the intention is to request a modification).
Inputs, Optional: (i) Use case context, (ii) Notification Address, (iii) Sensing Filter Information, (iv) Sensing Results Reporting, (v) Sensing Result Provision Strategy, (vi) if sensing focuses on objects: (vi.a) Sensing Description, (vi.b) Sensing Object ID, (vii) Sensing KPIs, (viii) Preparation Flag.
Outputs, Required: When the subscription is accepted: Transaction ID (required for any subscription transaction) and Expiry time (required if the subscription can be expired based on the operator's policy). When the preparation flag is active then the response indicates if the preparation conditions were met or not. When the subscription is not accepted, an error response or a sensing termination notification. Outputs, Optional: First corresponding sensing report is included, if available.
Note: When the Nnef_SensingExposure_Subscribe is used it may contain at least the following parameters but not limited to: (i) (set of) Sensing ID(s), (ii) Area of Interest, (iii) Target UEs (if applicable), (iv) Target Time Period of Sensing Subscription.

### Nnef_SensingExposure_Unsubscribe Service Operation

Service operation name: Nsf_SensingExposure_Unsubscribe
Description: The SF service consumer unsubscribes to an existing SF subscription on sensing results.
Inputs, Required: Transaction ID.
Outputs, Required: Operation execution result indication.

### Nnef_SensingExposure_Notify Service Operation

Service operation name: Nnef_SensingExposure_Notify.
Description: NEF reports the sensing result to the SF service consumer that has previously subscribed.
Inputs, Required: If the request is accepted: (i) Sensing ID(s)/Event ID(s), (ii) Sensing Result, (iii) Transaction ID that has been assigned by the SF service consumer during the subscription. When the request is not accepted, an error response or a sensing termination notification.
Inputs, Optional: (i) Timestamp of Generating a Sensing Result, (ii) Location of Target Object, (iii) Confidence in Sensing Prediction, (iv) Revised waiting time, (v) Object ID that identifies the different objects contained in the sensing result in relation with the Object Type ID (if sensing focuses on objects) or (vi) Environment Condition ID.
Outputs, Required: Operation execution result indication.

### Nnef_SensingExposure_Preparation Service Operation

Service operation name: Nnef_SensingExposure_Preparation.
Description: Optional preparation for an untrusted AF before issuing a request to SF sensing results with specific parameters.
Inputs, Required: (i) (set of) Sensing ID(s), (ii) Sensing Filter Information (e.g., Area of Interest, UE(s) of interest, Time window of interest).
Inputs, Optional: (i) Use case context, (ii) Target of Sensing Reporting (per Sensing ID), (iii) Sensing Filter Information, (iv) Sensing Results Reporting, (v) Sensing Result Provision Strategy, (vi) if sensing focuses on objects: (vi.a) Sensing Description, (vi.b) Sensing Object Type ID, (vii) Sensing KPIs.
Outputs Required: When the subscription preparation is accepted a positive acknowledgement. Otherwise, if the subscription preparation cannot be fulfilled, a negative response indicating the cause, e.g., wireless resource shortage, object out of range, etc.
Outputs, Optional: None.

### Nnef_SensingExposure_Fetch Service Operation

Service operation name: Nnef_SensingExposure_Fetch.
Description: The SF service consumer requests sensing results.
Inputs Required: (i) (set of) Sensing ID(s)/Event ID(s), (ii) Target of Sensing Reporting (per Sensing ID and/or Event ID), (iii) Time window of interest.
Inputs, Optional: (i) Use case context, (ii) Notification Address, (iii) Sensing Filter Information, (iv) Sensing Results Reporting, (v) Sensing Result Provision Strategy, (vi) if sensing focuses on objects: (vi.a) Sensing Description, (vi.b) Sensing Object ID, (vii) Sensing KPIs, (viii) Preparation Flag.
Outputs Required: If the request is accepted: (i) Sensing ID(s)/Event ID(s), (ii) Sensing Result, When the preparation flag is active then the response indicates if the preparation conditions were met or not. When the request is not accepted, an error response or a sensing termination notification.
Outputs, Optional: (i) Timestamp of Generating a Sensing Result, (ii) Location of Target Object, (iii) Confidence in Sensing Prediction, (iv) Revised waiting time, (v) Object ID that identifies the different objects contained in the sensing result in relation with the Object Type ID (if sensing focuses on objects) or (vi) Environment Condition ID.
Note: When the Nnef_SensingExposure_Fetch is used it may contain at least one the following parameters but not limited to: (i) (set of) Sensing ID(s), (ii) Area of Interest, (iii) Target UEs (if applicable), (iv) Time window of interest.

The input and outputs related to the newly proposed sensing service operations described above shall be perceived as examples. The new sensing service operations can be realized by including at least one of the proposed listed parameters without being restricted only by the list of parameters included per different service operation example.

In an aspect, there is provided an apparatus, for example a SF, in a wireless communication system, the apparatus comprising: a processor; and a memory coupled with the processor. The memory contains instructions which, when executed by the processor, cause the apparatus to: receive a service request issued by a consumer entity (for example, a SF service consumer and/or AF), wherein the service request is either: a subscription request for the consumer entity to be subscribed to receiving sensing results (e.g., in accordance with or as specified by one or more subscription parameters specified in the service request); or a request for the consumer entity to receive a single (e.g., one-off) response comprising sensing result (for example, a request to receive only a single set of sensing data in a single response); collect sensing data in accordance with the service request; process sensing data and transmit the sensing result for use by the consumer entity.

In embodiments in which the service request is the subscription request for the consumer entity to be subscribed to receiving sensing results, the memory may further contain instructions which, when executed by the processor, cause the apparatus to subscribe the consumer entity to receive sensing results in accordance with the service request.

The memory may further contain instructions which, when executed by the processor, cause the apparatus to, prior to receiving the service request, receive a preparation message that comprises one or more requirements of the service request. In some embodiments, if all of the one or more requirements of the service request can be met by the apparatus, the apparatus may transmit, for use by the consumer entity, a confirmation message confirming that all of the one or more requirements of the service request can be met by the apparatus, and/or the service request can be supported. In some embodiments, if one or more of the one or more requirements of the service request cannot be met by the apparatus, the apparatus may transmit, for use by the consumer entity, a notification indicating that the service request cannot be supported and/or that the one or more requirements of the service request cannot be met by the apparatus, and optionally defining also the possible cause, i.e., the reason why one or more requirements of the service request cannot be met by the apparatus.

The service request may be received from the consumer entity (which may be an AF, e.g. an untrusted AF) via an intermediate entity, such as a NEF. The service request received via the intermediate entity, e.g. the NEF, may have been processed by the intermediate entity to apply one or more restrictions or filters to the service request.

The service request may contains one or more parameters selected from the group of parameters consisting of:
a Sensing ID, which may identify a type of sensing to be performed in order to collect the sensing data;
a sensing event identifier, i.e., an Event ID which may identify an event that triggers the collection, generation, or sensing of the sensing results;
a sensing description, which may provide sensing dimensions or shape of a target entity or object or environment condition, include positioning information of an object, an expected velocity, orientation, heading, or movement direction, or a subset or combination thereof.
an AI/ML model prepared, i.e., trained, to identify sensing dimensions or shape of a target entity or object or environment condition, include positioning information of an object, an expected velocity, orientation, heading, or movement direction, or a subset or combination thereof.
a target entity or object, e.g. a UE of interest, in relation to which, on which, or for which the sensing results are requested. This may be specified per Sensing ID(s) and/or Event ID(s). For example, the service request may include a request that sensing of one or more target objects (in a target area) is performed and that sensing data is collected;
a target area in which sensing is to be conducted, e.g. a target area, which may be a geographical area, in which one or more target entities are to be sensed/measured;
a mobility profile for a target entity;
a time period during which the sensing data is to be collected, processed and/or transmitted, e.g., a target time period for the sensing result subscription if the sensing is related to a subscription;
a transaction ID, which may be an identifier identifying a successful subscription to receive sensing data by the consumer entity e.g., if subscription is already established and the intention is to request a modification;
an object ID or environment condition ID, which may be used to identify a previously sensed, i.e., spotted, object or environment condition;
a use case context;
a notification address to which to transmit the sensing results;
sensing filter information, which may indicate one or more conditions that are to be fulfilled before collecting and/or transmitting the sensing results;
a parameter indicating how the sensing results is to be reported, i.e. a Sensing Result Reporting parameter;
a provision strategy for the sensing results, i.e. a Sensing Result Provision Strategy;
a key performance indicator, KPI, or QoS requirement, for the sensing data; and/or
a permission, restriction and/or preference for a sensor technology.

The memory may further contain instructions which, when executed by the processor, cause the apparatus to transmit, for use by the consumer, one or more parameters selected from the group of parameters consisting of:
a timestamp for the sensing result, which may indicate when the sensing result was generated and/or transmitted;
a target ID or object ID, which may identify a target entity in relation to which, on which, or for which the sensing data is collected;
a location of a target entity or target object e.g., a UE of interest;
an environment condition ID, which may identify a condition of an environment in which the sensing data was collected;
a transaction ID, for example an identifier identifying a successful subscription to receive sensing results by the consumer entity e.g., if subscription is already established and the intention is to request a modification;
a confidence level associated with the sensing result, i.e. a Confidence in Sensing Prediction; and/or
an indication of a (e.g., revised) waiting time for providing the sensing results.

The apparatus may be a Sensing Function, SF. The consumer entity may be either a SF service consumer or an Application Function, AF.

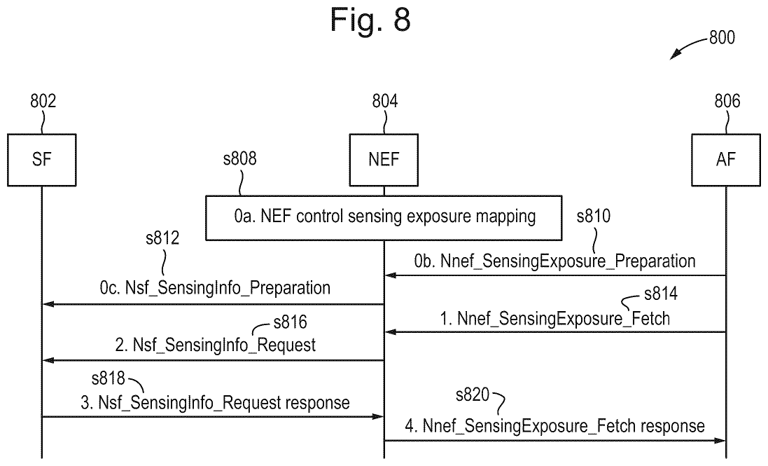

In a further aspect, there is provided a method in an apparatus (e.g., a SF) in a wireless communication system. FIG. 9 illustrates a process flow chart showing certain steps of this method 900. The method 900 comprises: receiving 902 a service request issued by a consumer entity (e.g. a SF service consumer and/or AF), wherein the service request is either: a subscription request for the consumer entity to be subscribed to receiving sensing results (for example, in accordance with one or more subscription parameters specified in the service request), or a request for the consumer entity to receive a single (e.g. one-off) response comprising sensing results (for example, a request to receive only a single sets of sensing results in a single response); collecting 904 sensing data in accordance with the service request; and process the sensing data to create sensing results and transmitting the sensing result for use by the consumer entity 906.

In embodiments in which the service request is the subscription request for the consumer entity to be subscribed to receiving sensing data; the method may further comprise subscribing the consumer entity to receive sensing results in accordance with the service request.

The method 900 may further comprise, prior to receiving a service request: receiving a preparation message that comprises one or more requirements of the service request. If all of the one or more requirements contained in the service subscription can be met by the apparatus, the apparatus may send, for use by the consumer entity, a confirmation message confirming that the sensing service can be met by the apparatus. If one or more of the one or more requirements of the service request cannot be met by the apparatus, the apparatus may send (e.g., in an error message), for use by the consumer entity, a notification indicating that the one or more requirements of the service request cannot be met by the apparatus, and optionally the respective cause of the one or more requirements not being met.

The service request may be received from the consumer entity (which may be an AF, e.g. an untrusted AF)] via an intermediate entity, such as an NEF. The service request received via the intermediate entity (e.g., the NEF) may have been processed by the intermediate entity to apply one or more restrictions to the service request.

In certain embodiments, the method 900 may be performed by a processor executing program code, for example, a microcontroller, a microprocessor, a CPU, a GPU, an auxiliary processing unit, a FPGA, or the like.

In a further aspect, there is provided an apparatus (e.g., a NEF) in a wireless communication system, the apparatus comprising a processor and a memory coupled with the processor. The memory contains instructions which, when executed by the processor, cause the apparatus to: receive, from a consumer entity (e.g. an AF such as an untrusted AF), a service request, wherein the service request is either: a subscription request for the consumer entity to be subscribed to receiving sensing results (e.g. in accordance with one or more subscription parameters specified in the service request); or a request for the consumer entity to receive a single (e.g. one-off) response comprising sensing results (for example, a request to receive only a single sets of sensing results in a single response); process the service request to enforce one or more restrictions on one or more parameters of the service request; and transmit the processed service request to a Sensing Function in the wireless communication system.

The memory may further contain instructions which, when executed by the processor, cause the apparatus to: receive, from the Sensing Function, in response to the processed service request, sensing results; process the sensing results to enforce one or more restrictions on one or more parameters of the sensing results; and transmit the processed sensing results to the consumer entity.

In a further aspect, there is provided an apparatus (e.g., a NEF) in a wireless communication system, the apparatus comprising a processor and a memory coupled with the processor. The memory contains instructions which, when executed by the processor, cause the apparatus to: receive, from a Sensing Function, sensing results for transmission to a consumer entity (e.g. an AF such as an untrusted AF); process the sensing results to enforce one or more restrictions on one or more parameters of the sensing results; and transmit the processed sensing results to the consumer entity. The one or more restrictions may be determined, e.g. by the apparatus, from a service request received by the apparatus from the consumer entity. The service request may be either: a subscription request for the consumer entity to be subscribed to receiving sensing results (e.g., in accordance with one or more subscription parameters specified in the service request); or a request for the consumer entity to receive a single (e.g. one-off) response comprising sensing results (for example, a request to receive only a single sets of sensing results in a single response).

In any preceding aspect, the memory may further contain instructions which, when executed by the processor, cause the apparatus to map a transaction ID to a service request, for example to a successfully fulfilled service request.

In any preceding aspect, the memory may further contain instructions which, when executed by the processor, cause the apparatus to map a transaction ID to a successful subscription of the consumer entity to receive sensing data from the Sensing Function.

In any preceding aspect, the memory may contain instructions which, when executed by the processor, cause the apparatus to maintain a record of one or more mappings. Each mapping may identify a transaction ID related to a successful subscription of the consumer entity to receive sensing results from the Sensing Function.

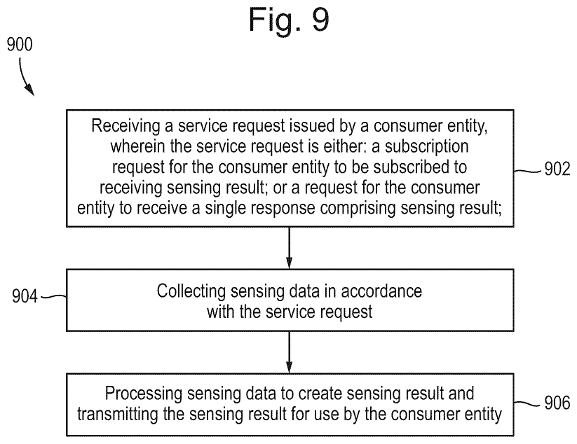

In a further aspect, there is provided a method in an apparatus (e.g., a NEF) in a wireless communication system. FIG. 10 illustrates a process flow chart showing certain steps of this method 1000. The method 1000 comprises: receiving 1002, from a consumer entity (e.g. an AF such as an untrusted AF), a service request, wherein the service request is either: a subscription request for the consumer entity to be subscribed to receiving sensing result (e.g. in accordance with one or more subscription parameters specified in the service request); or a request for the consumer entity to receive a single (e.g. one-off) response comprising sensing result; processing 1004 the service request to enforce one or more restrictions on one or more parameters of the service request; and transmitting 1006 the processed service request to a Sensing Function in the wireless communication system.

In certain embodiments, the method 1000 may be performed by a processor executing program code, for example, a microcontroller, a microprocessor, a CPU, a GPU, an auxiliary processing unit, a FPGA, or the like.

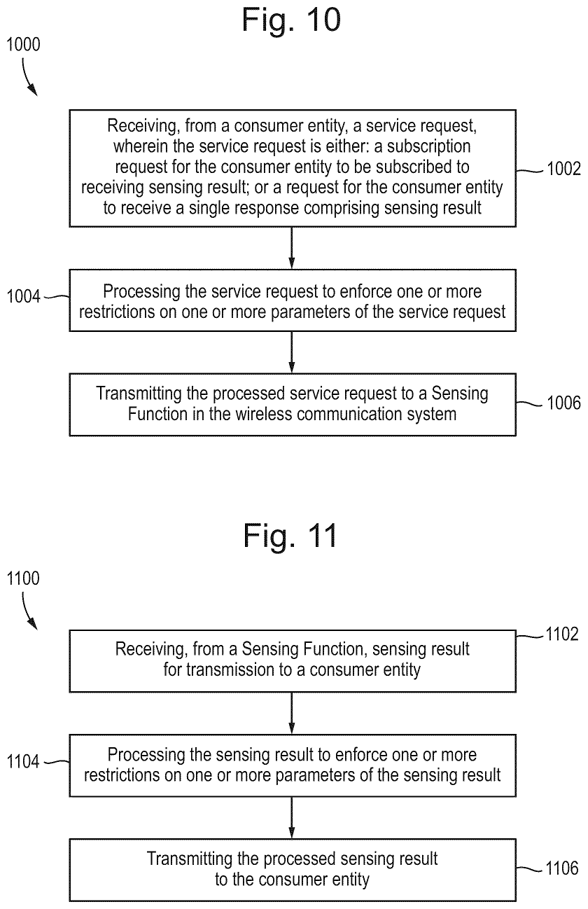

In a further aspect, there is provided a method in an apparatus (e.g., a NEF) in a wireless communication system. FIG. 11 illustrates a process flow chart showing certain steps of this method 1100. The method 1100 comprises: receiving 1102, from a Sensing Function, sensing results for transmission to a consumer entity (e.g., an AF such as an untrusted AF); processing 1104 the sensing result to enforce one or more restrictions on one or more parameters of the sensing result; and transmitting 1106 the processed sensing result to the consumer entity. The one or more restrictions may be determined from a service request received by the apparatus from the consumer entity, wherein the service request is either: a subscription request for the consumer entity to be subscribed to receiving sensing result (e.g. in accordance with one or more subscription parameters specified in the service request); or a request for the consumer entity to receive (e.g. only) a single (e.g. one-off) response comprising sensing result.

In certain embodiments, the method 1100 may be performed by a processor executing program code, for example, a microcontroller, a microprocessor, a CPU, a GPU, an auxiliary processing unit, a FPGA, or the like.

The method of any preceding aspect may further comprise maintaining a record of one or more transaction IDs, each transaction ID identifying a successful subscription of the consumer entity to receive sensing result from the Sensing Function.

Currently, the sensing service has no formal definition of a subscription or request service operation to allow a sensing service consumer to request sensing results. If such a sensing consumer is an untrusted AF, there is a need for enhancing NEF service operations to handle sensing subscriptions or requests. Sensing in many cases deals with moving UEs or objects, e.g., considering vehicles or drones. The sensing request preferably reflects potential mobility specific attributes related to moving UE or objects. In addition, sensing requests should preferably be able to handle environmental conditions.

The apparatuses and methods described herein propose: (i) sensing procedures for preparation, subscribing and requesting sensing services considering trusted and untrusted consumers, (ii) the content of sensing exposure focusing on, inter alia, object, environment conditions and mobility aspects, and (iii) sensing operations for subscribing, requesting, notifying, reporting, and fetching sensing results in the context on sensing procedure for subscribing and requesting sensing services.

The current state of the art has not yet developed a formal procedure for subscribing and requesting sensing results, especially for untrusted sensing service consumers. In addition, there is no means to capture object, environment conditions, and mobility aspects when issuing a sensing subscription or request.

The apparatuses and methods described herein provide the means for asking for sensing services such as: i) Subscribe to and unsubscribe from a sensing service considering trusted and untrusted consumers, specifying all related service operations; and ii) Request a sensing service considering trusted and untrusted consumers, specifying all related service operations.

The present disclosure provides an apparatus and method that enable a sensing function or a logical sensing function contained in the mobile operator network to receive a request from service consumer and to response providing the sensing results to the service consumer.

The service consumer may subscribe to or unsubscribe from receiving sensing results.

The service consumer may request sensing results.

The subscription or sensing request may contains at least one of the following parameters: a set of Sensing ID(s) and/or Event ID(s); a target of sensing reporting per Sensing ID(s) and/or Event ID(s); a sensing description, a target period of sensing subscription (if the sensing is related to a subscription); a transaction ID (if subscription is already established and the intention is to request a modification); a use case context; a notification address; Sensing Filter Information; Sensing Results Reporting information; a Sensing Result Provision Strategy; sensing KPIs; and/or, if sensing focuses on objects, Sensing Object Type ID.

A preparation step may be performed before the subscription or request is issued/sent.

The subscription notification may contain the sensing result per Sensing ID/Event ID, the transaction ID, and/or at least one of the following parameters: a timestamp of generating a Sensing Result; a location of a target object; a transaction ID (e.g. if subscription is already established and the intention is to request a modification); a confidence in sensing prediction; a revised waiting time, an Object ID that identifies the different objects contained in the sensing result in relation with the Object Type ID (if sensing focuses on objects); and/or an Environment Condition ID.

The SF may issue a sensing termination to the sensing consumer to unsubscribe from the sensing function service.

The sensing subscription and notification may be controlled by an exposure function that may: authorize untrusted sensing service consumers; keep track of the Transaction ID related to successful subscriptions; enforce the inbound restriction related to the service parameters allowed for an untrusted consumer; and/or enforce the and outbound restrictions related to the service parameters allowed for an untrusted consumer.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope. Further, while examples have been given in the context of particular communication standards, these examples are not intended to be the limit of the communication standards to which the disclosed method and apparatus may be applied. For example, while specific examples have been given in the context of 3GPP, the principles disclosed herein can also be applied to another wireless communication system, and indeed any communication system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations are relevant in the field addressed by this document:

| | |
|---|---|
| 3GPP | 3rd Generation Partnership Project |
| 5G | 5th Generation of Mobile Communication |
| AI/ML | Artificial Intelligence/Machine Learning |
| AF | Application Function |
| AMF | Access and Mobility Management Function |
| CP | Control Plane |
| EPC | Evolved Packet Core |
| E-UTRA | Evolved Universal Terrestrial Radio Access |
| GLMC | Gateway Mobile Location Centre |
| GPS | Global Positioning System |
| IMT-2020 | International Mobile Telecommunications-2020 |
| ISAC | Integrated sensing and communication |
| LMF | Location Management Function |
| NEF | Network Exposure Function |
| NF | Network Function |
| NR | New Radio |
| NRF | Network Repository Function |
| NWDAF | Network Data Analytics Function |
| OAM | Operations, Administration and Maintenance |
| PCF | Policy Control Function |
| RAN | Radio Access Network |
| RF | Radio Frequency |
| SF | Sensing Function |
| S-NSSAI | Single - Network Slice Selection Assistance Information |
| TA | Tracking Area |
| UDM | User Data manager |
| UE | User Equipment |
| UP | User Plane |

1. An apparatus for wireless communication, comprising:
at least one memory; and
at least one processor coupled with the at least one memory and configured to cause the apparatus to:
receive a service request from a consumer entity, wherein the service request is either:
a subscription request for the consumer entity to be subscribed to receive a sensing result; or
a request for the consumer entity to receive a single response associated with a sensing result, and
wherein the service request identifies a sensing type for a sensing service performed by the apparatus;
collect sensing data based on the service request;
process the sensing data to create the sensing result; and
transmit the sensing result to the consumer entity.

2. The apparatus of claim 1, wherein the service request is the subscription request and the at least one processor is further configured to cause the apparatus to
to subscribe the consumer entity to receive the sensing result based on the service request.

3. The apparatus of claim 2, wherein, prior to receiving the service request, the at least one processor is further configured to cause the apparatus to:
receive a preparation message that includes one or more requirements of the service request; and
when all of the one or more requirements of the service request are met by the apparatus, transmit a confirmation message indicating that all of the one or more requirements of the service request are met by the apparatus; or
when one or more of the one or more requirements of the service request are not met by the apparatus, transmit a notification indicating that the one or more requirements of the service request are not met by the apparatus.

4. The apparatus of claim 1, wherein the at least one processor is configured to cause the apparatus to receive the service request from the consumer entity
via an intermediate entity.

5. The apparatus of claim 4, wherein:
the consumer entity is an Application Function, AF; or
the intermediate entity is a Network Exposure Function (NEF) or a gateway.

6. The apparatus of claim 1, wherein the service request contains one or more parameters, including:
a Sensing ID;
a sensing event identifier;
a sensing description for a target entity or object or environment condition;
an artificial intelligence or machine learning (AI/ML) model for a target entity or object or environment condition;
a target entity for which the sensing result is requested;
a target area in which sensing is to be conducted;
a mobility profile for a target entity;
a time period during which the sensing result is to transmitted;
a transaction ID;
an object ID for a previously sensed and reported object;
an environment condition ID for a previously sensed and reported environment condition;
a use case context;
an address to which to transmit the sensing result;
sensing filter information indicating one or more conditions to be fulfilled before collecting sensing data or transmitting the sensing result;
a parameter indicating how the sensing result is to be reported;
a provision strategy for the sensing result;
a key performance indicator (KPI) for the sensing data; or
a permission, restriction, or preference for a sensor technology.

7. The apparatus of claim 1, wherein the sensing result contains one or more parameters, including:
a timestamp for the sensing result;
an object ID or environment condition ID for which the sensing data is collected;
a location of a target entity;
an environment condition ID identifying a condition of an environment in which the sensing data was collected;
a transaction ID;
a confidence level associated with the sensing result; or
an indication of a waiting time for providing the sensing result.

8. The apparatus of claim 1, wherein:
the apparatus is a Sensing Function (SF); or
the consumer entity is either an SF service consumer or an Application Function (AF).

9.-12. (canceled)

13. An apparatus for wireless communication, comprising:
at least one memory; and
at least one processor coupled with the at least one memory and configured to cause the apparatus to:
receive, from a consumer entity, a service request, wherein the service request is either:
a subscription request for the consumer entity to be subscribed to receive a sensing result; or
a request for the consumer entity to receive a single response associated with a sensing result;
process the service request to enforce one or more restrictions on one or more parameters of the service request; and
transmit the processed service request to a Sensing Function in the wireless communication system.

14. The apparatus of claim 13, wherein the at least one processor is further configured to cause the apparatus to:
receive, from the Sensing Function, in response to the processed service request, the sensing result;
process the sensing result to enforce the one or more restrictions on the one or more parameters of the sensing result; and
transmit the processed sensing result to the consumer entity.

15. An apparatus for wireless communication, comprising:
at least one memory; and
at least one memory coupled with the at least one processor and configured to cause the apparatus to:
receive, from a Sensing Function, a sensing result for transmission to a consumer entity;
process the sensing result to enforce one or more restrictions on one or more parameters of the sensing result; and
transmit the processed sensing result to the consumer entity.

16. The apparatus of claim 14, wherein:
the consumer entity is an Application Function (AF); or
the apparatus is a Network Exposure Function (NEF) or a gateway.

17. The apparatus of claim 15, wherein the at least one processor is further configured to cause the apparatus to map a transaction ID to a service request received from the consumer entity and associated with the sensing result.

18. The apparatus of claim 15, wherein the at least one processor is further configured to cause the apparatus to map a transaction ID to a successful subscription of the consumer entity to receive the sensing result from the Sensing Function.

19. The apparatus of claim 15, wherein the at least one processor is further configured to cause the apparatus to maintain a record of one or more mappings, each mapping identifying a transaction ID associated with a successful subscription of the consumer entity to receive the sensing result from the Sensing Function.

20.-22. (canceled)

23. The apparatus of claim 1, wherein the service request contains one or more parameters, including:
a Sensing ID;
a target area in which sensing is to be conducted;
an object ID for a previously sensed and reported object; and
a key performance indicator (KPI) for the sensing data.

24. The apparatus of claim 1, wherein the service request contains one or more parameters, including:
a Sensing ID;
a target area in which sensing is to be conducted;
a mobility profile for target entity within the target area; and
a use case context.

25. A method performed by an apparatus, the method comprising:
receiving a service request from a consumer entity,
wherein the service request is a subscription request to be subscribed to receive a sensing result or a request for to receive a single response associated with a sensing result, and
wherein the service request identifies a sensing type for a sensing service performed by the apparatus;
collecting sensing data based on the service request;
generating a sensing result that includes the collected sensing data; and
transmitting the sensing result to the consumer entity.

26. The method of claim 25, wherein the service request contains one or more parameters, including:
a Sensing ID;
a sensing event identifier;
a sensing description for a target entity or object or environment condition;
an artificial intelligence or machine learning (AI/ML) model ifor a target entity or object or environment condition;
a target entity for which the sensing result is requested;
a target area in which sensing is to be conducted;
a mobility profile for a target entity;
a time period during which the sensing result is to transmitted;
a transaction ID;
an object ID for a previously sensed and reported object;
an environment condition ID for a previously sensed and reported environment condition;
a use case context;
an address to which to transmit the sensing result;
sensing filter information indicating one or more conditions to be fulfilled before collecting sensing data or transmitting the sensing result;
a parameter indicating how the sensing result is to be reported;
a provision strategy for the sensing result;
a key performance indicator (KPI) for the sensing data; or
a permission, restriction, or preference for a sensor technology.

27. The method of claim 25, wherein the service request contains one or more parameters, including:
a Sensing ID;
a target area in which sensing is to be conducted;
an object ID for a previously sensed and reported object; and
a key performance indicator (KPI) for the sensing data.
